(19) United States
(12) Patent Application Publication
(10) Pub. No.: US 2002/0166995 A1
(43) Pub. Date: Nov. 14, 2002

(54) Paraffin wax inhibitors

(75) Inventors: Alison M. Robinson, Long Valley, NJ (US); Jonathan R. Stromberg, West Paterson, NJ (US); Michael J. Jurek, Jefferson Township, NJ (US); Kirill N. Bakeev, Ringwood, NJ (US)

Correspondence Address: INTERNATIONAL SPECIALTY PRODUCTS, William J. Davis, Esq., Legal Dept., Bldg. 10, 1361 Alps Road, Wayne, NJ, 07470-3529, US

(73) Assignee: ISP INVESTMENTS INC.

(21) Appl. No.: 09/800,546

(22) Filed: Mar. 7, 2001

(51) Int. Cl. C09K 3/00

(52) U.S. Cl. 252/380

(57) ABSTRACT

A method of enhancing the efficacy of a polymeric wax inhibitor for an oil which comprises applying said inhibitor in an aliphatic glycol ether solvent.

### BACKGROUND OF THE INVENTION

1. Field of the Invention

This invention relates to paraffin wax inhibitors for crude oil, and, more particularly, to the use of a glycol ether solvent to enhance the efficacy of polymeric paraffin wax inhibitors.

2. Description of the Prior Art

U.S. Pat. No. 5,721,201 (Feb. 24, 1998): Copolymers of maleic anhydride with a N(C₈-C₃₀-alkyl) (meth)acrylate is used as a flow additive.

U.S. Pat. No. 2,704,277 (Mar. 15, 1955): Esterified copolymers of alkyl or vinyl ethers and polybasic carboxylic acids such as maleic anhydride are used as flow additives.

U.S. Pat. No. 4,900,331 (Feb. 13, 1990): The pour point viscosity, or viscosity index, of oils (crude, fuel, mineral, etc.) are improved by addition of alkyl amine or alkyl mercaptan derivatives of a copolymer of an alpha olefin or an alkyl vinyl ether and maleic anhydride.

U.S. Pat. No. 3,449,236 (Jun. 10, 1969): Dewaxing of petroleum oil is aided by addition of a polymer of maleic anhydride or a derivative with a non-conjugated diolefin. Especially effective are polymers that have been esterified, amidated, or imidated.

U.S. Pat. No. 3,449,250 (Jun. 10, 1969): Copolymer of maleic anhydride and alpha-olefin of MW 500-150,000 improves dispersancy and detergency in oils. The copolymer is made oil soluble by esterifying the carboxyl groups with an aliphatic alcohol.

U.S. Pat. No. 3,329,658 (Jul. 7, 1969): Some properties of fuel and lubricating oils are improved by the use of oil-soluble polymeric compounds such as copolymers of maleic anhydride and an alpha-olefin such as ethylene, propylene, isobutylene, styrene, or a mixture of such olefins.

U.S. Pat. No. 3,879,177 (Apr. 22, 1975): Inhibition of wax crystallization in a crude oil is aided by addition of a copolymer of maleic anhydride and vinyl methyl ether which is esterified with an alcohol containing 18 to 24 carbon atoms.

U.S. Pat. No. 2,677,662 (Aug. 2, 1948): Novel materials that are useful as pour point depressants and for improving the viscosity of lube oils include high molecular weight copolymers of maleic acid or its anhydride with other unsaturated alkyl compounds and their derivatives, and esters of such copolymers. The product may have side chains supplied from the alkyl part of a vinyl alkyl derivative which is copolymerized with the maleic acid or derivative thereof, or, from the alcohol used to esterify the copolymer.

U.S. Pat. No. 3,536,461 (Oct. 27, 1970): Long chain fatty alcohol esters of styrene/maleic anhydride copolymers are effective pour point depressants in shale oils.

U.S. Pat. No. 3,574,575 (Apr. 13, 1971): Fluidity of liquid hydrocarbon oils is improved by addition of esters of styrene/maleic anhydride copolymers, especially esters which have at least 20 carbon atoms in the alkyl chain.

U.S. Pat. No. 4,663,491 (May 5, 1987): Copolymers of maleic anhydride and esters of acrylic or methacrylic acid with unbranched alcohols containing at least 16 carbon atoms are used as crystallization inhibitors in paraffin containing crude oils.

These and other polymeric inhibitors generally are present in aromatic solvents.

Accordingly, it is an object of this invention to provide a new and improved, efficacious polymeric wax inhibitor composition for crude oil which includes a biodegradable organic solvent in place of all or part of environmentally unfriendly aromatic solvents.

A feature of this invention is the use of a glycol ether solvent for a polymeric wax inhibitor to prevent or substantially reduce paraffin wax deposition in crude oils.

These and other objects and features of the invention will be made apparent from the following description of the invention.

### SUMMARY OF THE INVENTION

It has been discovered that the efficiency of a polymeric paraffin wax inhibitor used for treating crude oil is substantially improved by the addition of a glycol ether, e.g. ethyleneglycol monobutylether (BGE) to the inhibitor product.

### DETAILED DESCRIPTION OF THE INVENTION

In this invention, the presence of an aliphatic glycol ether solvent in a polymeric wax inhibitor composition substantially reduces or prevents paraffin wax deposition in crude oil. This important improvement can be achieved while simultaneously providing a more biodegradable and environmentally friendly composition for the industry.

Suitable glycol ether solvents include low molecular glycol ethers containing an alkoxy group having at least 3 carbon atoms. Representative glycol ethers include 2-butoxyethanol (ethylene glycol monobutyl ether); propylene glycol butyl ether; (diethylene glycol) monobutyl ether; and 2-isopropoxy-ethanol, 2-Butoxyethanol (BGE) is preferred.

The aliphatic glycol ether herein may be used to wholly replace the traditional aromatic solvents, or in substantial amounts in a mixture with such solvent. Generally, the composition of the invention includes, by wt., 5-35% polymeric wax inhibitor, 5-90% aliphatic glycol ether and 0-75% aromatic co-solvent, suitably 40-80% glycol ether and 10-30% aromatic co-solvent.

Typical polymers include copolymers of maleic anhydride with alkyl vinyl ethers, such as octadecyl vinyl ether, or alpha-olefins, or alkyl(meth)acrylates, which may be esterified, amidated or imidated, or vinyl pyrrolidone with alpha-olefins.

The invention is illustrated further in the following examples:

### COLD FINGER WAX DEPOSITION TEST

A model crude oil was made from mixing paraffin wax, xylenes, decane and hexane in a weight ratio of 10:10:40:40 in the case of Model Oil 1(MO1) or 31.5:25.5:15.0:28.0 in the case of Model Oil 5 (MO5) and heating with constant stirring to and held at 45° C. for MO1 or 55° C. for MO5 for a minimum of 15 minutes. A weighed 120.0 g±2.0 g sub-sample of the model oil was weighed into an 8 oz glass jar, an aliquot of test chemical sufficient to result in 500 ppm (typically 350 μl of a 20% solids solution) solids based on total fluids was added along with a magnetic stirrer bar. Test chemical consisted of a test polymer dissolved in varying ratios of solvents, including the test solvent BGE as specified in the examples below. Up to 12 such jars were prepared.

A U-shaped cold finger was screwed onto the jars and the assembly was placed on magnetic stirrer plates set to an operating speed of 150 rpm. Cooled circulant maintained the cold finger temperature at 10° C. for MO1 and 25° C. for MO5 while a cabinet enclosing the jar matrix maintained a temperature of 25° C. for MO1 and 36° C. for MO5. After 18 hours the tubes were removed from the jars, and any deposited wax was visually inspected, scraped/wiped off, dried under vacuum at 40° C. for 3 hours and weighed. The amount of wax deposited was expressed as a percentage of the total amount of wax added initially to the 8 oz jars. The values of three or more repeated experiments are then averaged.

When the cold finger deposition experiment was conducted with no added test chemical (as a blank) the above procedure was similarly followed. In an attempt to minimize the effect of thermal gradient across the cold finger apparatus, blanks were run in random positions. In the case of Model Oil 1, a mean blank value of 0.8% deposit was calculated and for Model Oil 5 a mean value of 0.9%. These mean blank values were used to normalize the test chemical mean values to produce the percentage amount of wax which was inhibited from depositing onto the cold finger surface. Accordingly, the %Wax inhibited=(Mean blank %−mean polymer%)/mean blank%. To demonstrate BGE had no effect on wax deposition, test experiments were performed whereby BGE was added to the blank tests to simulate conditions without added polymer. In all tests BGE had no significant impact on the wax deposition in the absence of a test chemical inhibitor.

The repeatability of these tests in the case of (the higher wax content) MO5 was ±5%. Since the deposited wax layer for MO1 was less firm, slightly higher errors were obtained.

### EXAMPLE 1

A 4-necked glass round bottom flask was charged with 25 g Solvesso®-150, 18.2 g octadecylvinyl ether (ODVE, 0.0612 mole), and 6.1 g maleic anhydride (0.0616 mole), and fitted with an overhead stirrer, thermocouple, condenser and a rubber septum for syringe addition of initiator. The reaction mixture was heated to 95° C. Then lauroyl peroxide (4.92×10⁻⁷ mole) initiator was dissolved in 4 g xylenes and a 20 wt % aliquot of the initiator solution was added via syringe. A second addition of 40 wt % initiator solution was added after 1 hour and the final aliquot was added after 2 hours. The reaction was run for 2 hours and stopped. The molecular weight of the resulting polymer was 43,400, measured by GPC with Shodex KF 807L column, mobile phase of tetrahydrofuran, 0.5% v/v trifluoroacetic acid, ambient temperature, 0.5 ml/min flow rate and calibrated against polystyrene.

Using the cold finger test conditions for MO1 and the following test chemicals:

| | |
|---|---|
| Comparative | 50% Polymer, 50% Solvesso ®-150*: |
| Example 1.1: | Wax inhibited-25%. |
| Example 1.2: | 12.5% Polymer, 12.5% Solvesso ®-150, 75% BGE: |
| | Wax inhibited->98%. |

*blend of aromatic solvents (EXXON)

### EXAMPLE 2

A 4-necked glass round bottom flask was charged with 25 g BGE, 18.2 g octadecylvinyl ether (ODVE, 0.0612 moles), and 5.8 g maleic anhydride (0.059 mole), and fitted with an overhead stirrer, thermocouple, condenser and a rubber septum for syringe addition of initiator. The reaction mixture was heated to 95° C. Lauroyl peroxide (9.84×10⁻⁴ moles) initiator was dissolved in 4 g tetrahydrofuran. A 40 wt % aliquot of the initiator solution was added via syringe. A second addition of 40 wt % initiator solution was added after 1 hour and the final aliquot was added after 2 hours. The reaction was run for 2 hours. The molecular weight of the resulting polymer was 26,100, as measured by the GPC method of Example 1.

Using the cold finger test conditions for MO1 and the following test chemicals:

| | |
|---|---|
| Example 2.1: | 20% Polymer, 80% BGE: Wax inhibited-25%. |
| Example 2.2: | 20% Polymer, 20% BGE: 60% Solvesso ®-150: |
| | Wax inhibited-40%. |
| Example 2.3: | 20% Polymer, 53.3% BGE: 26.7% Solvesso ®-150: |
| | Wax inhibited->98%. |

### EXAMPLE 3

Ganex® V220-ISP Corp. was dissolved in solvents as indicated below. Using the cold finger test conditions for MO5 and the following test chemicals:

| | |
|---|---|
| Comparative | 20% Polymer: 80% Solvesso ®-150: |
| Example 3.1: | Wax inhibited-40%. |
| Example 3.2: | 10% Polymer: 77% BGE: 13% Solvesso ®-150: |
| | Wax inhibited-65%. |

### EXAMPLE 4

A maleic anhydride/octadecylvinylether copolymer was synthesized in a 2-I vessel, a stainless steel reactor under a 3-10 psi nitrogen (gas) head pressure. The details of the process are as follows:

1) The octadecylvinylether with toluene (ODVE solution) previously charged into pump C was transferred to the stainless steel reactor and agitated at 250 rpm while purging the system five times with nitrogen gas.

2) In a 1/2-gallon glass jar, maleic anhydride (MAN) (molten) was charged and dissolved in toluene (MAN solution). Under cold temperature, this mixture can crystallize. Therefore, the maleic anhydride/toluene solution was heated before transferring to its syringe pump.

3) The lauroyl peroxide (LPO) taken from a freezer was dissolved in toluene. This mixture was the initiator solution; it was transferred to its syringe pump.

4) The reactor filled with the ODVE solution was raised to 92° C. over a one-hour period at an agitation rate of 250 rpm.

5) Maleic anhydride/toluene was charged to pump B whereas the initiator solution was charged to syringe pump A.

6) Both the maleic anhydride/toluene and the initiator solution (LPO/toluene) were fed into the reactor simultaneously during two hours at 92° C.

7) Finally, the reactor was cooled to 30° C. over 15 minutes and the product was discharged.

COMPOSITION

| Ingredient | Amount (g) |
|---|---|
| MAN | 59.8 |
| Toluene | 246.5 |
| ODVE | 183.3 |
| Toluene | 91.6 |
| LPO | 1.99 |
| Toluene | 23.3 |

The molecular weight of the resulting polymer was 680,000, measured by GPC as in Example 1.

Toluene was removed by drying from the product where necessary to allow testing as shown below.

The cold finger test conditions for MO1 and the following test chemicals:

| | |
|---|---|
| Comparative | 20% Polymer: 80% Xylenes: |
| Example 4.1: | Wax inhibited-0%. |
| Example 4.2: | 20% Polymer: 80% BGE: Wax inhibited-55%. |

### EXAMPLE 5

In this example the polymer was synthesized as in Example 4 but the amount of initiator was increased by a factor of 2.45. The molecular weight of the resulting polymer was 126,000, measured by GPC as in Example 1. Again, toluene was dried from the product where necessary for testing.

Using the cold finger test conditions for MO1 and the following test chemicals:

Comparative Example 5.1:20% Polymer:80% Xylene: Wax inhibited—60%

Example 5.2: 20% Polymer:80% BGE Wax inhibited—>98%.

What is claimed is:

1. A method of enhancing the efficacy of a polymeric wax inhibitor for an oil which comprises applying said inhibitor in an aliphatic glycol ether solvent.

2. A method according to claim 1 wherein said glycol ether is ethyleneglycol monobutylether.

3. A paraffin wax inhibitor composition for an oil which includes an aliphatic glycol ether solvent.

4. A composition according to claim 3 wherein said glycol ether is ethyleneglycol monobutylether.

5. A composition according to claim 3 which comprises, by wt, 5-35% polymeric wax inhibitor, 5-90% of an aliphatic glycol ether and 0-75% aromatic solvent.

6. A composition according to claim 5 wherein said glycol ether is ethyleneglycol monobutylether.

7. A composition according to claim 5 which includes 20-80% glycol ether and 10-80% aromatic solvent.

8. A composition according to claim 5 wherein said polymeric wax inhibitor is maleic anhydride/octadecylvinylether and/or Ganex® V220 copolymer.
